(19) United States
(12) Patent Application Publication
(10) Pub. No.: US 2014/0150328 A1
(43) Pub. Date: Jun. 5, 2014

(54) FISHING FLOAT WITH CATCH INDICATOR

(71) Applicant: O. Spincer Harrell, Flora, MS (US)

(72) Inventor: O. Spincer Harrell, Flora, MS (US)

(21) Appl. No.: 13/692,663

(22) Filed: Dec. 3, 2012

(51) Int. Cl. A01K 93/02

(52) U.S. Cl. CPC A01K 93/02
USPC 43/17; 43/17.5

(57) ABSTRACT

There is provided a fishing float comprising a buoyant, elongated hollow body, a means for attaching a fishing line to the first end of the hollow body, a dead-weight slideable from end to end inside the hollow body, and a lamp module attached in proximity to the second end of the hollow body. The lamp module is comprised of a lamp, an electric power source, and a switch, all elements in a series electrical circuit. The lamp module is further comprised of conductive ball and a plurality of annular chambers that house the conductive ball in a stable condition apart from the electric switch while the hollow body is in a horizontal orientation; but when the hollow body is moved toward a vertical orientation by force of a fish strike, the annular chambers direct the conductive ball into bridging contact with the electrical switch, which closes the electrical circuit and activates the lamp. The fishing float remains illuminated in the event a fish caught on the fishing line relaxes tension on the fishing line.

### TECHNICAL FIELD OF THE INVENTION

The present invention relates, in general, to fishing floats, and, in particular, to a float which provides a visual signal when a fish is caught. More particularly, the present invention relates to a fishing float having a gravity actuated switch which activates a light when force is applied to a fishing line and having a stabilizing means to keep the light illuminated when tension on the fishing line is released.

### BACKGROUND OF THE INVENTION

Fishing is often accomplished by use of a pole to which a line is secured. In such settings, a bobber is often secured at a point along the line, and the fisher observes the action of the bobber, watching for a fish to tug the line and disturb the bobber. Jugline fishing is an alternative fishing technique that is commonly accomplished by securing a hook and line to a float or “jug” without the use of a pole. A jugline fisher can place several jugs in the water at the same time, since, unlike pole-line fishing, the jugs do not require as much individual attention. A jugline fisher may chose to secure several jugs together or secure one or more jugs to an anchored object. A jugline fisher may chose to check each jug only periodically to determine if a fish has been caught. Compared to pole-line fishing, jugline fishing requires less attention for each line. Still, a jugline fisher must keep track of the location of each jug and then check each jug individually to determine whether a fish has been caught. A jugline fisher has the option to check the jugs more often or less often, comparatively. The less often the jugs are checked, the more likely a fish will be caught without being retrieved quickly—which increases the chances that a caught fish will be lost. Both pole-line and jugline fishing are often done at night. When fishing in low-light conditions, whether with a pole-line or a jugline, fishers benefit from a light indicating a fish is caught on the line.

A number of inventions have presented fishing floats or bobbers that disclose a battery connected in a series electrical circuit with a light bulb and a switch that closes the circuit upon a tug by a fish on the line to which the float is attached. Many of these inventions rely on a biasing means, such a spring, to hold the circuit open until a fish overcomes the biasing tension by pulling on the line, at which point force on the line applied by the fish causes movement of a mechanical means which closes the electrical circuit and thereby activates the light. Examples of such inventions include: U.S. Pat. Nos. 2,534,709; 2,722,763; 2,914,879; 3,292,294; 3,608,227; 3,739,513; 5,052,145; 5,351,432; 5,615,512; 5,974,721. Typically in such inventions, the light is deactivated if the force on the line applied by the fish is relaxed, because a release of tension on the line allows the biasing device to return the mechanical means to its original position. Such releasing of tension on the fishing line is a common in fishing, typically occurring where a fish once caught by the hook on the end of the fishing line swims toward the float or otherwise stops pulling on the line.

Other inventions have presented fishing floats or bobbers that include a battery connected in a series electrical circuit with a light bulb and a switch that closes the circuit upon the tug by a fish on the line to which the float is secured, with these inventions relying on a mercury switch to close the circuit and thereby activate the light. Examples include, U.S. Pat. Nos. 2,205,352 and 4,486,969. Typically, these inventions present a bobber that is weight-biased to float in an inverted orientation, an inverted orientation being one that places the light bulb downward and the other end of the bobber (the end to which the fishing line having a hook is connected) upward. When a fish pulls the hook and the attached line, tension on the line causes the bobber to change its orientation from a bulb downward position to a bulb upward position. This rotation of the bobber in conjunction with gravity causes mercury in a container to flow from a first end of the container (with the circuit open) to a second end of the container, where the mercury closes the connection between open circuit connectors, thereby activating the light. Typically in such inventions, if the fish releases tension on the fishing line, the bobber returns to its weight-biased, original orientation, which deactivates the light.

Still other inventions have presented fishing floats or bobbers that include a battery connected in a series electrical circuit with a light bulb and a switch that closes the circuit upon the tug by a fish on the line to which the float is secured, with these inventions relying on gravity and the movement of a mechanical device to close the circuit and thereby activate the light. For example, U.S. Pat. No. 2,128,899 (issued to Barnhart, Sep. 6, 1938), discloses a bobber that is weight-biased to float in an inverted orientation, with the bobber housing a ball that is movable on a lever and fulcrum device. Tension on the fishing line resulting from a tug by a fish causes the bobber to reverse its orientation, which in conjunction with gravity causes the ball to roll from a first position (circuit open) along the lever to a second position, where the weight of the ball causes the lever to change position, which closes the circuit and thereby activates the light. If the fish releases the tension on the fishing line, the bobber returns to its initial weight-biased position, thereby reversing the ball position and deactivating the light.

Another example, U.S. Pat. No. 2,517,479 (issued to Grimm, Aug. 1, 1950) discloses a fishing bobber that houses a ball in a trapezoidal shaped chamber. The bobber is weight biased to float in a horizontal orientation. While the bobber is in a horizontal orientation, the ball rests in a first (lower) end of a trapezoidal chamber. When tension on the fishing line caused by a fish strike pulls the bobber into a vertical orientation, the change in orientation in conjunction with gravity causes the ball to roll to a second end of the trapezoidal shaped chamber, where the ball made of conductive material makes contact with exposed and opposing connectors thereby closing an electrical circuit and activating a light. If tension on the fishing line is released, the bobber returns to its original weight-biased position, which causes the light to be deactivated.

As another example, U.S. Pat. No. 4,748,761 (issued to Machovina, Jun. 7, 1988) discloses a bobber housing a tubular member in tubular chamber. The bobber is weight-biased to float in an inverted orientation. Tension on the fishing line resulting from a fish strike causes the bobber to reverse its orientation, which in conjunction with gravity causes the tubular member to slide from a first position (circuit open) along the tubular chamber to a second position, where the tubular member made of electrically conductive material closes the circuit thereby activating the light. If tension on the fishing line is relaxed, the bobber returns to its initial weight-biased position, thereby reversing the tubular member's motion and position and deactivating the light.

U.S. Pat. No. 5,758,449 (issued to Munsterman et al., Jun. 2, 1998) presents a jugline float that includes a battery connected in series with a light bulb and a switch that closes the circuit upon the tug by a fish on the line to which the float is secured. The float has two sources of light indication (i.e., two bulbs). The first light is activated by operation of the fisher. The second light is activated by tension on the fishing line caused by a fish pulling on the line. A spring biased pivot arm holds the circuit open until force on the fishing line resulting from the fish pull causes the pivot arm to change position, which closes the circuit and activates the second light. If tension on the fishing line is released, spring tension returns the pivot arm to its original position, thereby opening the circuit and deactivating the light.

Generally, a fish caught by a hook and pulling on a fishing line exerts significant force on the fishing line. This force is the source of activation of lighted floats and bobbers in the above mentioned devices. However, it is common that, after an initial period of intense struggle, a caught fish will move to a position that releases tension on the fishing line. Bobbers or floats that return to an inverted state (i.e., light off) when tension on the fishing line is relaxed will not continue to produce a visual signal for a fisher to observe, even though a fish is caught and remains on the line. Therefore, for both jugline and pole-line fishers there remains a need for a float that will provide a visual signal indicating a fish is caught after the caught fish has released tension on the fishing line. While the above mentioned devices are directed to floats that illuminate when a fish is initially caught, none discloses a float that will continue providing visual indication after the caught fish has released tension on the fishing line. Inasmuch as the art is relatively crowded with respect to various types of illuminated fishing floats, it can be appreciated that there is a continuing need for and interest in improvements to illuminated fishing floats, and in this respect, the present invention addresses this need and interest.

### SUMMARY OF THE INVENTION

A fishing float having a catch indicator light is disclosed. A primary object of the present invention is to provide a fishing float that will give a fisher a visual indication whenever a fish is caught on the line to which the float is attached.

In accordance with one aspect of the invention, there is provided a float comprising a buoyant, elongated hollow body having first and second ends, a clip or similar means for attaching a fishing line to the first end of the elongated hollow body, a dead-weight slideable from first to second end of the hollow body and back, and a lamp module attached in proximity to the second end of the hollow body. The lamp module is comprised of a compartment that contains a lamp, an electric power source, and a switch, all of which are elements in a series electrical circuit. The lamp module is further comprised of conductive ball and a plurality of annular chambers that hold the conductive ball in a relatively stable position apart from the switch while the hollow body is in a horizontal orientation; but when the hollow body is moved toward a vertical orientation by force of a fish tug on the fishing line attached to the first end of the elongated hollow body, the annular chambers direct the conductive ball into bridging contact with the electrical switch, which closes the electrical circuit and activates the lamp.

Another object of the invention is to provide a fishing float that will, once illuminating a lamp when a fish is caught on a line, remain illuminated when the fish relaxes tension on the fishing line.

A further object of the invention is to provide a fishing float that can accommodate different levels of force required to illuminate the indicator light of the fishing float.

Other objects, features and objectives of the invention will be found throughout the following description, the drawings and the claims.

### BRIEF DESCRIPTION OF THE DRAWINGS

For a more complete understanding of the features and advantages of the present invention, reference is now made to the detailed description of the invention along with the accompanying figures in which corresponding numerals in different figures refer to corresponding parts and in which:

FIG. 1 is a cross-sectional view of the preferred jugline embodiment of the fishing float in accordance with the present invention.

FIG. 2 is a cross-sectional view of the lamp module of the preferred embodiment in accordance with the present invention.

FIG. 3 is a cross-sectional view of the preferred bobber embodiment in accordance with the present invention.

### DETAILED DESCRIPTION OF THE INVENTION

For a more complete understanding of the features and advantages of the present invention, reference is now made to the detailed description of preferred embodiments of the invention along with the accompanying figures in which corresponding numerals in different figures refer to corresponding parts and in which:

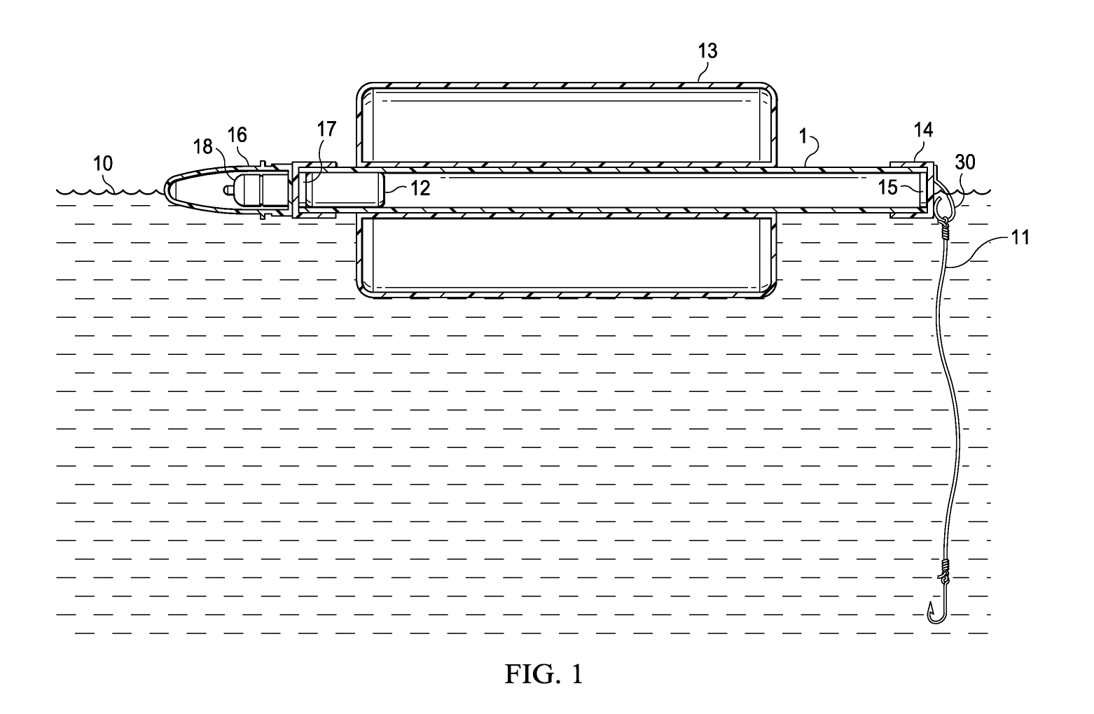

Illustrated in FIG. 1 is the fishing float of the present invention, in a jugline embodiment, floating on the surface of a water body 10 while connected to a fishing line 11. Fishing line 11 is shown relatively taut as supporting the weight of the hook, bait or lure, leader, and any fishing weights that may be attached to the line, but not sufficient weight to tip the float from its relatively stable horizontal orientation.

As can be seen in FIG. 1, the float of the present invention is comprised of an elongated hollow body 1 having first and second ends, which may have a first end cap 14 fastened to the first end of hollow body 1, and a second end cap 16 fastened to the second end of hollow body 1, which hollow body and end caps may form a buoyant, watertight compartment. The float is further comprised of a dead-weight 12, a floatation support 13, and a lamp module 18. The float may have a clip 30 or eyelet or similar means for securing a fishing line to first end cap 14. Lamp module 18 may be attached to second end cap 16 or to hollow body 1 in proximity to second end cap 16. Hollow body 1 may be of any shape (e.g. quadrangular, hexagonal, etc.), though in the preferred embodiment, it is cylindrical in shape. Dead-weight 12 may be slideably engaged inside the compartment of hollow body 1 and slideable between first end cap 14 and second end cap 16. A first bumper 15 may be placed adjacent to first end cap 14, and a second bumper 17 may be placed adjacent to second end cap 16 to cushion the impact of dead-weight 12 when it slides from second end cap 16 to first end cap 14 (and vice versa) inside the compartment of hollow body 1. Floatation support 13 may be of any shape and attached to hollow body 1 at any location, though in the preferred embodiment floatation support 13 is cylindrical shaped and attached around hollow body 1. Floatation support 13 may be made of any buoyant material, such as closed cell foam or extruded polystyrene foam; and floatation support 13 may be of such size to accommodate the size of fish a fisher desires to attract.

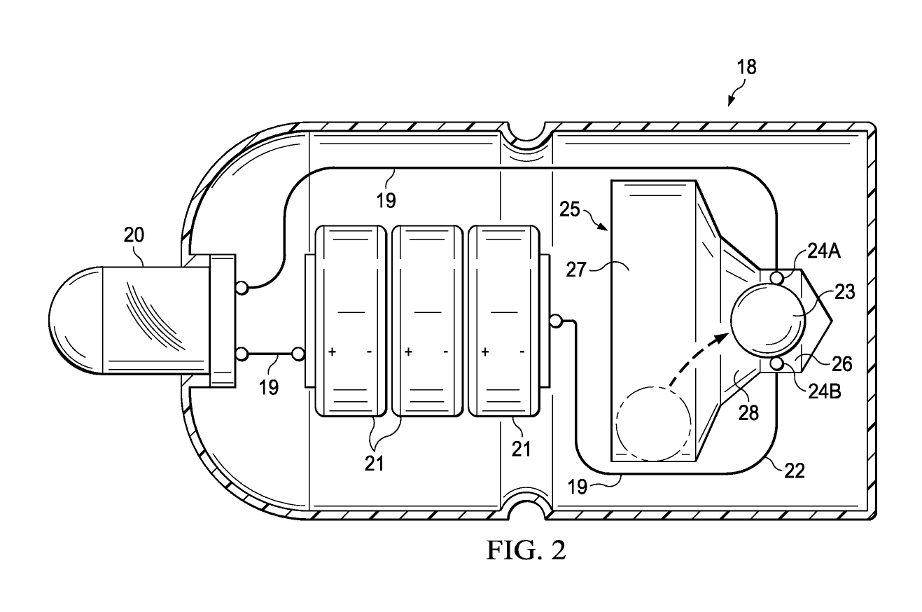

As can be seen in FIG. 2, lamp module 18 may be comprised of a compartment that contains a lamp 20, an electric power source 21, and a switch 22, all of which are elements in a series electrical circuit 19 so that bridging by a conductive ball 23 of switch contacts 24a and 24b results in illuminating lamp 20 by using electrical power from electric power source 21. In the preferred embodiment, electric power source 21 is a battery. Lamp module 18 is further comprised of a ball race 25 suitably sized to receive conductive ball 23. Ball race 25 is comprised of a plurality of annular chambers which are concentric and contiguous, which plurality includes a first annular chamber 26, a second annular chamber 27, and a third annular chamber 28, with first annular chamber 26 having the smallest outer diameter and being sized to receive conductive ball 23 such that when conductive ball 23 is moved into first annular chamber 26, switch contacts 24a and 24b are closed by contact with conductive ball 23. Second annular chamber 27 is sized such that it has an outer diameter larger in dimension that the first annular chamber 26. Second annular chamber 27 allows conductive ball 23 to remain in a relatively stable condition while hollow body 1 and lamp module 18 are in a horizontal orientation. Third annular chamber 28 is positioned contiguous to and between first annular chamber 26 and second annular chamber 27. Third annular chamber 28 has an outer diameter that changes in dimension from the dimension of first annular chamber 26's outer diameter to the dimension of second annular chamber 27's outer diameter. The slope at which the outer diameter of third annular chamber 28 changes from the outer diameter of first annular chamber 26 to the outer diameter of second annular chamber 27 may be a single angle or multiple angles. As may be seen in FIG. 2, the slope at which the outer diameter of third annular chamber 28 changes from the outer diameter of first annular chamber 26 to the outer diameter of second annular chamber 27 may be two discrete angles, the first being a greater angle in relation to the axis of the annular chambers, and the second being a lesser angle in relation to the axis of the annular chambers. It is one of the unique features of this invention that, by varying the slope at which the outer diameter of the third annular chamber 28 changes, the float may be biased to require more (or less) change in orientation of hollow body 1 and correspondingly more (or less) force necessary to cause such change in orientation to activate lamp 20.

It will be appreciated that lamp module 18 may be attached inside the compartment of hollow body 1 between second end cap 16 and second bumper 17, or attached on the exterior of second end cap 16, or lamp module 18 may be constructed integrally with second end cap 16. It will be further appreciated that all or part of hollow body 1 may be made of translucent or transparent material such that light from lamp 20 may be observed from outside hollow body 1 when lamp module 18 is placed inside hollow body 1 and lamp 20 is illuminated. Similarly all or part of second end cap 16 may be made of translucent or transparent material such that light from lamp 20 may be observed from outside end cap 16 when lamp module 18 is constructed integrally with second end cap 16 and lamp 20 is illuminated. In like fashion, lamp module 18 may be made of translucent or transparent material such that light from lamp 20 may be seen when illuminated on lamp module 18 attached to the exterior of second end cap 16 and lamp 20 is illuminated.

In all cases in this specification and in the claims attached hereto, references to a lamp in the context of the present invention is intended to include any integrated electrical or electronic device that reproducibly and reliably produces light when an appropriate voltage is applied to appropriate terminals thereof. Thus are included light bulbs of every kind, light emitting diodes, as are integrated circuits capable of emitting light.

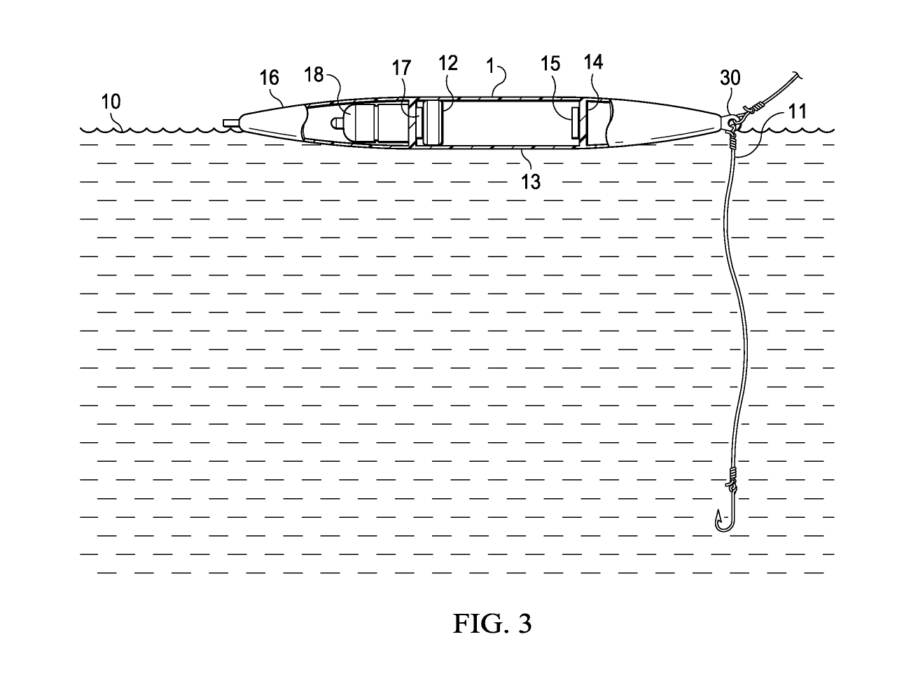

FIG. 3 shows the fishing float of the present invention in a pole-line bobber embodiment. As can be seen in FIG. 3, to accommodate pole-line fishing, the floatation support 13 of the present invention may be constructed integrally with the walls of hollow body 1; and the length of hollow body 1 may be minimized and first end cap 14 and second end cap 16 elongated to form a pole-line bobber.

In use, the present invention will float on the surface of a water body in a horizontal orientation, as seen in FIG. 1 and FIG. 3, or in an inverted position (not shown). Conductive ball 23 will rest in second annular chamber 27 and dead weight 12 will rest near the second end of hollow body 1. When a fish strikes the hook on line 11, downward force on line 11 will translate into downward force on the first end of hollow body 1, which will cause hollow body 1 to rotate toward a vertical orientation. Gravity in conjunction with said rotation of hollow body 1 will cause dead weight 12 to slide from the second end of hollow body 1 to the first end of hollow body 1, where it will be stopped by first bumper 15. Said rotation of hollow body 1 will change the orientation of lamp module 18 from its initial horizontal orientation toward a vertical orientation. As lamp module 18 changes orientation from horizontal toward vertical, gravity will cause conductive ball 23 to travel from second annular chamber 27 through third annular chamber 28 into first annular chamber 26, where conductive ball 23 will make contact with switch contacts 24a and 24b, which will close electrical circuit 19 and illuminate lamp 20. The slope at which the outer diameter of the third annular chamber 28 transitions between second annular chamber 27 and first annular chamber 26 (i.e. degree and number of angles) may be chosen in the manufacturing process so as to require more or less force (i.e. more or less rotation) to move conductive ball 23 from second annular chamber 27 to first annular chamber 26. Thus, a steeper sloped transition would prevent waves, choppy water, and fish nibbles, which are expected to cause slight rotation of hollow body 1 and lamp module 18, from causing the lamp 20 to illuminate. After hollow body 1 has changed orientation from horizontal to vertical, the force of gravity will hold dead weight 12 toward the first end of hollow body 1. It is a unique feature of this invention that dead weight 12 will keep lamp 20 illuminated under circumstances where a caught fish stops applying tension to line 11. In such circumstances, a jugline fisher who returns to check jugs will observe the present invention remaining illuminated, because the present invention will not return to the non-illuminated state when a fish releases tension on the fishing line.

While various embodiments of the invention have been described, the description is intended to be exemplary, rather than limiting and it will be apparent to those of ordinary skill in the art that other embodiments and implementations are possible that are within the scope of the invention. Accordingly, the invention is not to be restricted except in light of the attached claims and their equivalents.

The invention claimed is:

1. A fishing float comprising:
an elongated hollow body having first and second ends;
a first end cap fastened to said first end of said elongated hollow body;
a second end cap fastened to said second end of said elongated hollow body;
a dead-weight slidably positioned in said elongated hollow body, said dead-weight being slideable between said first end and said second end of said elongated hollow body;
a connecting means for connecting a fishing line to said first end of said elongated hollow body;
a flotation support attached to said elongated hollow body;
at least one lamp module attached on said second end of said elongated hollow body, said at least one lamp module comprising:
a lamp;
an electrical power source;
an electric circuit connecting said lamp and electric power source, said circuit having a first switch contact and a second switch contact;
a conductive ball,
a plurality of contiguous, concentric annular chambers sized to rollably house said conductive ball, with a first annular chamber housing said first switch contact and said second switch contact in a spaced apart relationship with each other, and said first annular chamber having a outer diameter sized to receive said conductive ball into a bridging relationship with said first switch contact and said second switch contact of said electric circuit, a second annular chamber having an outer diameter larger than the outer diameter of said first annular chamber, and a third annular chamber having an outer diameter that transitions from the dimension of the outer diameter of said first annular chamber to the dimension of the outer diameter of said second annular chamber.

2. The fishing float of claim 1 wherein said electric power source is a battery.

3. The fishing float of claim 1 wherein said second end of said elongated hollow body is translucent.

4. The fishing float of claim 1 wherein said second end said elongated hollow body is translucent and said electric power source is a battery.

5. The fishing float of claim 1 wherein said second end cap is translucent.

6. The fishing float of claim 1 wherein said second end cap is translucent and said electric power source is a battery.

7. A fishing float comprising:
a buoyant elongated hollow body having first and second ends;
a dead-weight slidably positioned in said elongated hollow body, said dead-weight being slideable between said first end and said second end of said elongated hollow body;
a connecting means for connecting a fishing line to said first end of said elongated hollow body;
at least one lamp module attached on said second end of said elongated hollow body, said at least one lamp module comprising:
a lamp;
an electrical power source;
an electric circuit connecting said lamp and electric power source, said circuit having a first switch contact and a second switch contact;
a conductive ball,
a plurality of contiguous, concentric annular chambers sized to rollably house said conductive ball, with a first annular chamber housing said first switch contact and said second switch contact in a spaced apart relationship with each other, and said first annular chamber having a outer diameter sized to receive said conductive ball into a bridging relationship with said first switch contact and said second switch contact of said electric circuit, a second annular chamber having an outer diameter larger than the outer diameter of said first annular chamber, and a third annular chamber having an outer diameter that transitions from the dimension of the outer diameter of said first annular chamber to the dimension of the outer diameter of said second annular chamber.

8. The fishing float of claim 7 wherein said electric power source is a battery.

9. The fishing float of claim 7 wherein said second end of said elongated hollow body is translucent.

10. The fishing float of claim 7 wherein said second end said elongated hollow body is translucent and said electric power source is a battery.

11. A fishing float comprising:
a buoyant elongated hollow body having first and second ends;
a dead-weight slidably positioned in said elongated hollow body, said dead-weight being slideable between said first end and said second end of said elongated hollow body;
at least one lamp module comprising:
a lamp;
an electrical power source;
an electric circuit connecting said lamp and electric power source, said circuit having a first switch contact and a second switch contact;
a conductive ball,
a plurality of contiguous, concentric annular chambers sized to rollably house said conductive ball, with a first annular chamber housing said first switch contact and said second switch contact in a spaced apart relationship with each other, and said first annular chamber having a outer diameter sized to receive said conductive ball into a bridging relationship with said first switch contact and said second switch contact of said electric circuit, a second annular chamber having an outer diameter larger than the outer diameter of said first annular chamber, and a third annular chamber having an outer diameter that transitions from the dimension of the outer diameter of said first annular chamber to the dimension of the outer diameter of said second annular chamber.

12. The fishing float of claim 11 wherein said electric power source is a battery.
